(19) United States
(12) Patent Application Publication
(10) Pub. No.: US 2009/0328149 A1
(43) Pub. Date: Dec. 31, 2009

(54) METHOD AND SYSTEM FOR MANAGING THE ACCESS AND USE OF ELECTRONIC FORMS

(76) Inventors: Joseph Lyons, Springfield, VA (US); Darren Collins, Wichita, KS (US); Michael Schreiner, Valrico, FL (US)

Correspondence Address: Muncy, Geissler, Olds & Lowe, PLLC, P.O. BOX 1364, FAIRFAX, VA, 22038-1364, US

(21) Appl. No.: 12/492,950

(22) Filed: Jun. 26, 2009

Related U.S. Application Data
(60) Provisional application No. 61/075,978, filed on Jun. 26, 2008.

(51) Int. Cl. G06F 17/00; G06F 21/00

(52) U.S. Cl. 726/3; 715/223

(57) ABSTRACT

A method and system is provided for authenticating electronic forms prior to download. A Form Administrator may enable authentication requirement for an End User and also select an authentication scheme. The End User will not be allowed access to an electronic form unless authenticated. The invention also includes a method and system for delivering and presenting electronic forms to an End User through a purely browser based application, without requiring the installation of additional software or browser plug-ins.

This application claims priority to Provisional Application No. 61/075,978, which was filed on Jun. 26, 2008, and which is herein incorporated by reference.

### BACKGROUND OF THE INVENTION

1. Field of the Invention

This invention relates in general to computer software and in particular to a method and system for managing access and use of electronic forms. The invention provides techniques for authentication, wherein administrators may control the distribution, access and download of electronic forms using a centrally-located authentication repository. The invention also provides techniques wherein end users may use electronic forms through the medium of a browser interface that interacts with a server-located form document, without the need for additional software or browser plug-ins.

2. Description of the Background Art

Electronic forms applications typically include three primary components: design software for the Form Author, filler software for the End User completing the form, and server software for the Form Distributor and/or Data Collector (the Form Distributor and the Data Collector may or may not be the same entity, and either may or may not be related to the Form Author). The Form Distributor and/or Data Collector will be collectively referred to as Form Administrator.

The design software is used to create the electronic form (e-form), or user interface of the data container, as well as the algorithms associated with the e-form and data to be entered into the e-form. The Form Author may design the e-form as a traditional electronic form or integrate elements of hypertext markup language (HTML), extensible markup language (XML), portable document format (PDF), graphic elements (e.g., GIF, TIF. JPEG) and other objects to achieve the desired user interface. The designer may also specify data edits, validation, and other functions such as encryption, glyph generation, e-mail routing information, etc. that govern the behavior of the e-form in the filler application.

Filler software allows End Users to view and interact with the e-forms created using the design software. Electronic operations which may be performed by the End User on the e-form include, filling out the e-form electronically, saving the e-form, submitting the e-form, and similar functions depending on the algorithms associated with the e-form by the designer.

Server software allows Form Administrators to distribute and process e-forms. The server software enables the Form Distributor to pre-fill forms with data from a database and distribute the pre-filled forms to End Users electronically (e.g., via email attachments or a hyperlink to a download URL from where the e-form may be downloaded). Optionally, the distributor may encrypt the pre-filled data, or subsets of the pre-filled data, prior to distributing the e-forms. Server software also enables Data Collectors to process incoming e-forms electronically and automatically. An example of such processing would be to receive the incoming e-form, identify the form, authenticate the form, decrypt the form, extract the data from the form, and write the data to a database.

Prior to this invention, an End User for whom access to an e-form was not intended by a Form Administrator, may nevertheless gain access to the e-form. For example, if an e-form is published at a download URL, the unintended End User may be able to download the e-form if the download URL is known. Alternatively, e-form Server software could employ security mechanisms outside of or in addition to the e-form framework to provide authentication and authorization for End Users to access e-forms.

Further, conventional Filler software requires the End User to download specialized software or plug-ins in order to perform operations such as entering data on the e-form electronically. Conventional Filler software which allow the End User to interact with an e-form through the medium of an internet browser, lack the capability to seamlessly transition from when the End User is “online” and connected to the internet, or “offline” and handling the e-form locally within the same session of use of the e-form.

### SUMMARY OF THE INVENTION

The present invention disclosed herein comprises a method and system for authenticating electronic forms prior to download. A Form Administrator may enable authentication requirement for an End User and also select an authentication scheme. The End User will not be allowed access to an electronic form unless authenticated by having supplied proper credentials into an authentication form presented by the Server software when a form is requested.

The invention also includes a method and system for delivering electronic forms to an End User through a purely browser based application, allowing the End User to interact with a server-located form document, without requiring the installation of additional software or browser plug-ins. This means of delivery and user interaction can rely on a server-based software application that utilizes Ajax technology along with software in order to render in a series of images sent to a browser resulting in a picture of the form document with which an End User is interacting. As the End User interacts with the rendered form by editing text or clicking on controls, small pieces of information are sent to the server-based application, resulting in updates to the server-located e-form followed by newly rendered images being sent back to the browser to reflect any End User modifications. The Ajax web development technique can be employed in the development of this application in order to allow for a very rich and interactive user interface that behaves like a standard (non-browser) application. Ajax (which stands for Asynchronous JavaScript and XML) defines a technique involving the use of JavaScript, XML, and other web standards, through the use of which small XML messages are passed back and forth between the browser and the server, allowing the server to provide changes to the client asynchronously in the background, thus eliminating the need for entire page refreshes to occur as a user interacts with the browser. Browser-side functionality is handled mainly through the use of JavaScript generated on the server and executed in the client browser. Using this technology, a document-based e-form hosted in memory on a server can be viewed and used by an End User without the need for the User to install any client software.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus, are not limitive of the present invention, and wherein:

FIG. 1 illustrates a graphic representation of a data processing system, according to an embodiment of the present invention;

FIG. 2 illustrates a graphic representation of an E-Forms Management system with built-in authentication software that can be connected to an external authentication repository, according to an exemplary embodiment;

FIG. 3 illustrates the fields in an exemplary authentication form;

FIG. 4 is a flow chart illustrating the process steps in an exemplary E-Forms Management system when an end user attempts to access an e-form;

FIG. 5 illustrates a graphic representation of an E-Forms Management system, wherein electronic forms are accessible through a purely browser based iFiller Application;

FIG. 6 is a schematic representation of the sequence of events which take place when an electronic form field is updated using the browser based iFiller Application; and

FIG. 7 is a flow chart representation of the sequence of events which take place when an electronic form field is updated using the browser based iFiller Application.

### DETAILED DESCRIPTION

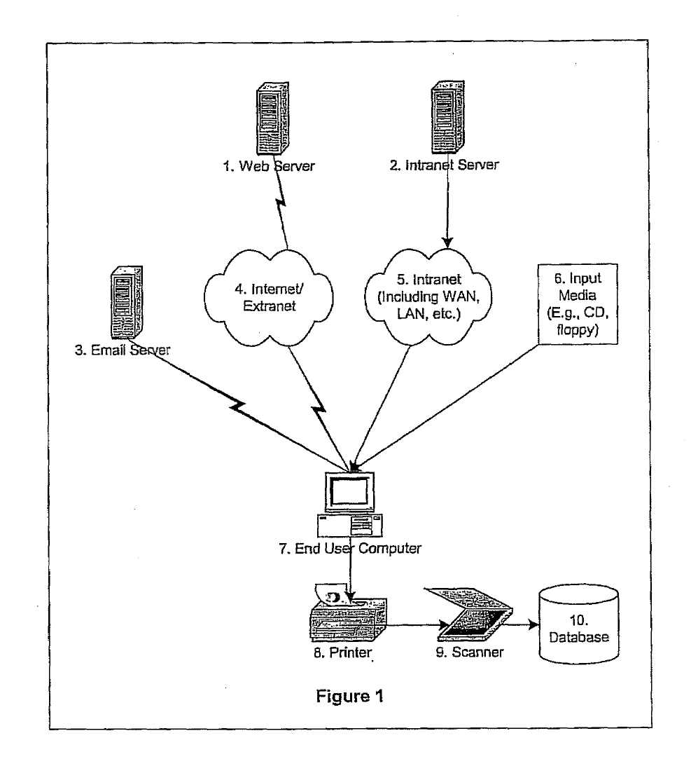

Referring to FIG. 1, there is depicted a graphic representation of a data processing system which may be utilized to implement the present invention. As may be seen, data processing system may include a plurality of networks, such as Local Area Network (LAN), Wide Area Network (WAN) and Internet, each of which may include a plurality of individual computers respectively. Those skilled in the art will appreciate that a plurality of workstations coupled to a host processor may be utilized for each such network. As is common in such data processing systems, each individual computer may be coupled to a storage device and/or printer/output device and/or input device.

The data processing system may also include multiple server computers, such as mainframe computer, which may be coupled to computer, LAN, WAN or Internet by means of communications link. The server computers may also be coupled to a storage device which may serve as remote storage for the End User computer, LAN, WAN or Internet.

Similarly, the End User computer, WAN and Internet may be coupled via communications link through a subsystem control unit/communications controller and communications link to a gateway server creating an inter-network link.

With respect to the End User computer, LAN, WAN and Internet, a plurality of documents or resource objects may be stored within storage device and controlled by a server computer, as resource manager or library service for the resource objects thus stored. Those skilled in the art will appreciate that the server computer may be located a great geographic distance from LAN and similarly, LAN may be located at a substantial distance from the End User computer. For example, the End User computer may be located in Colorado while the LAN may be located in Washington and the server computer may be located in New York.

Software program code which employs the present invention is typically stored in the memory of a storage device of a stand alone work station or storage device of a server computer from which a developer may access the code. For distribution purposes, the software program code may be embodied on any of a variety of known media for use with a data processing system, such as a diskette or CD-ROM or may be distributed to users from the memory of one computer system over a network of some type to other computer systems for use by users of such other systems. Such techniques and methods for embodying software code on media and/or distributing software code are well known and will not be further discussed herein.

With respect to the present invention, the End User 21 uses the End User computer 7 to access the e-form. According to an exemplary embodiment, the End User computer 7 is running software program code (Filler software) which employs the present invention. Configurable authentication features are built in to the software program, and allow Form Administrators to control access to e-form 20 by End User 21. Once authenticated, the e-form 20 is accessed directly from a storage device connected to the End User computer 7, such as a local hard drive, or from some form of input media 6, or from an email message from an email server 3, or from a communications link to the Internet/Extranet 4 and web server 1, or from a local Intranet 5 and Intranet server 2 or some similar access method. The End User 21 uses the End User computer 7 to view the e-form 20, fill in data 22 in the data fields 23, save the e-form 20, and to perform other similar actions.

In another exemplary embodiment, a server computer is running software program code which employs the present Invention. The e-form 20 is accessed directly from the server computer, presented, and acted upon purely through the medium of an internet browser. The End User computer 7 is not required to download or install additional software or internet browser plug-ins. In a further embodiment, authentication mechanisms can be built into the browser.

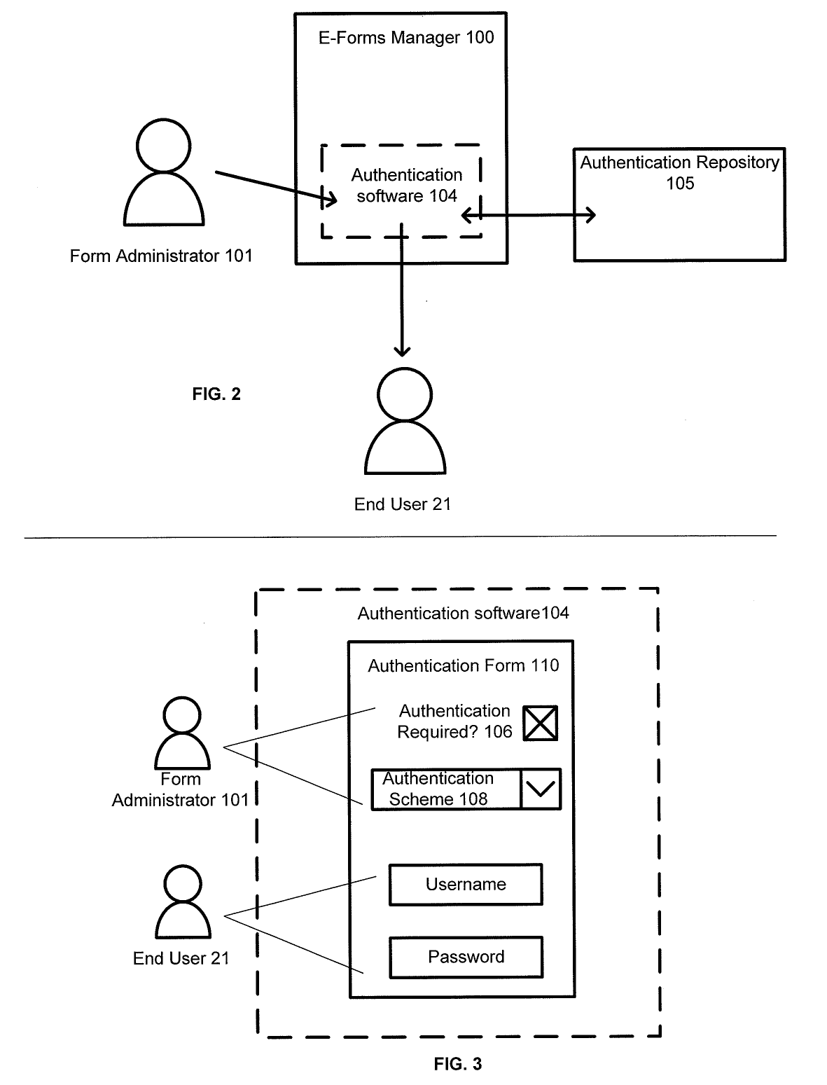

With reference to FIG. 2, E-Forms Manager (EFM) 100 represents server software which includes a repository of published e-forms 20, software to control and distribute e-forms, software for e-form retrieval and software for interacting with external devices such as End User computer 7. While one or more versions of e-form 20 may be available in the EFM 100, the features of an exemplary embodiment will be described with reference to an exemplary version of e-form 20, henceforth referred to simply as e-form 20.

Form Administrator 102 can configure Authentication software 104 to require authentication from End User 21 prior to download of e-form 20. Authentication software 104 includes one or more authentication schemes, from which Form Administrator 102 may select an authentication scheme for End User 21. An authentication scheme defines one or more searches against one or more external authentication repositories for purposes of authenticating and obtaining information about End Users based on credentials provided.

FIG. 3 is a schematic for Authentication Form 110, which is an interface to the Authentication software 104. Prior to download of e-form 20, the Form Administrator 102 may decide whether authentication is required for e-form 20 and enable authentication via check box 106. If authentication is enabled, a dropdown menu 108 allows Form Administrator 102 to select from one or more authentication schemes. If authentication is enabled and no authentication scheme is selected, then a default authentication scheme is assigned by the Authentication software 104. If authentication is not enabled, then no authentication scheme will be used.

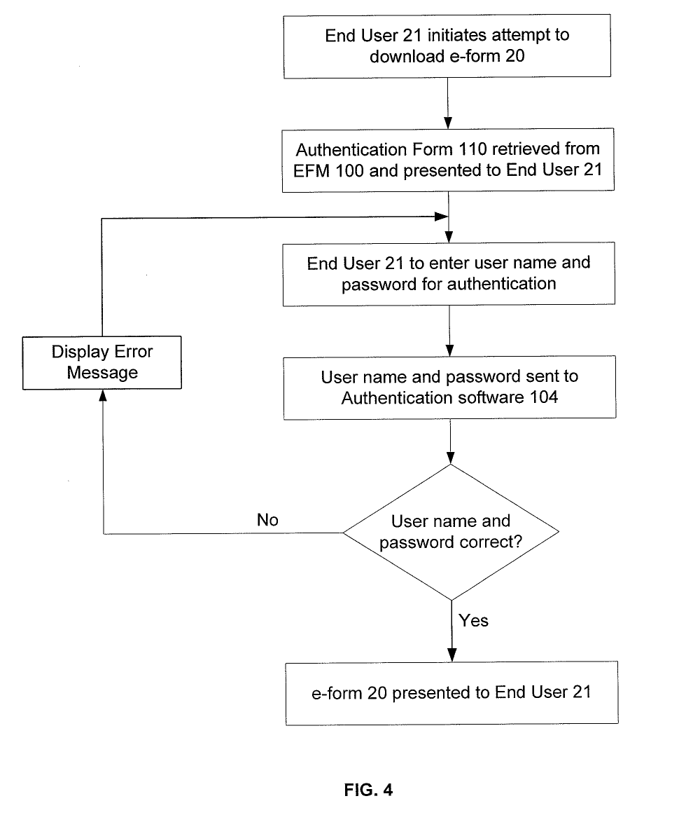

Assuming authentication is enabled and an authentication scheme is selected, End User 21 may attempt to download e-form 20 (for example, from the download URL where the e-form 20 is published in EFM 100). When EFM 100 receives the download request, the Authentication Form 110 associated with e-form 20 is sent to End User 21. End User 21 will need to supply authentication credentials, such as a username and password, in the Authentication Form 110, which is then submitted to the EFM 100. The Authentication software 104 in EFM 100 then verifies the authentication information in accordance with the specified authentication scheme. If authentication fails, then the Authentication Form 100 is returned to End User 21, and the process stalls until the End User 21 provides the correct credentials or cancels the operation. In case of authentication failure, the Authentication Form 100 also displays an error message that indicates that authentication failed. If authentication succeeds, then the originally requested e-form 20 is retrieved from EFM 100 and presented to End User 21. A flow chart of the process steps described above is illustrated in FIG. 4.

The EFM 100 may query multiple authentication providers for authentication schemes, including Active Directory Servers, LDAP servers, SQL-compliant data bases and also an authentication repository built in to EFM 100. These authentication schemes may be available for Form Administrator 104 to select from dropdown menu 108. Similar to the mechanism described above for download of e-form 20, these authentication schemes may also be assigned to other operations that may involve authentication of End User 21, such as submission, signing and Auto-fill of e-form 20.

Multiple Authentication Providers and Schemes which define queries against different authentication repositories and different queries against the same repository may be defined in EFM 100. This allows Form Administrator 102 to configure policies that determine which end users, (for example, either inside or outside an organization), can download specific published e-forms. In an illustrative example, by using two separate authentication schemes that perform different searches against the same Active Directory Server, it is possible to allow any employee of a company to download an expense report e-form, while allowing only Human Resources personnel to download an Employee Action e-form.

Once a pre-download Authentication Form 110 has been configured by Form Administrator 102, EFM 100 handles all the actions required for processing pre-download authentication of e-form 20. In this embodiment, EFM 100 uses Filler software to broker the communication between End User 21 and the authentication repositories, instead of utilizing the medium of an internet browser. Embodiments which utilize a purely browser based interface to access electronic forms are described below.

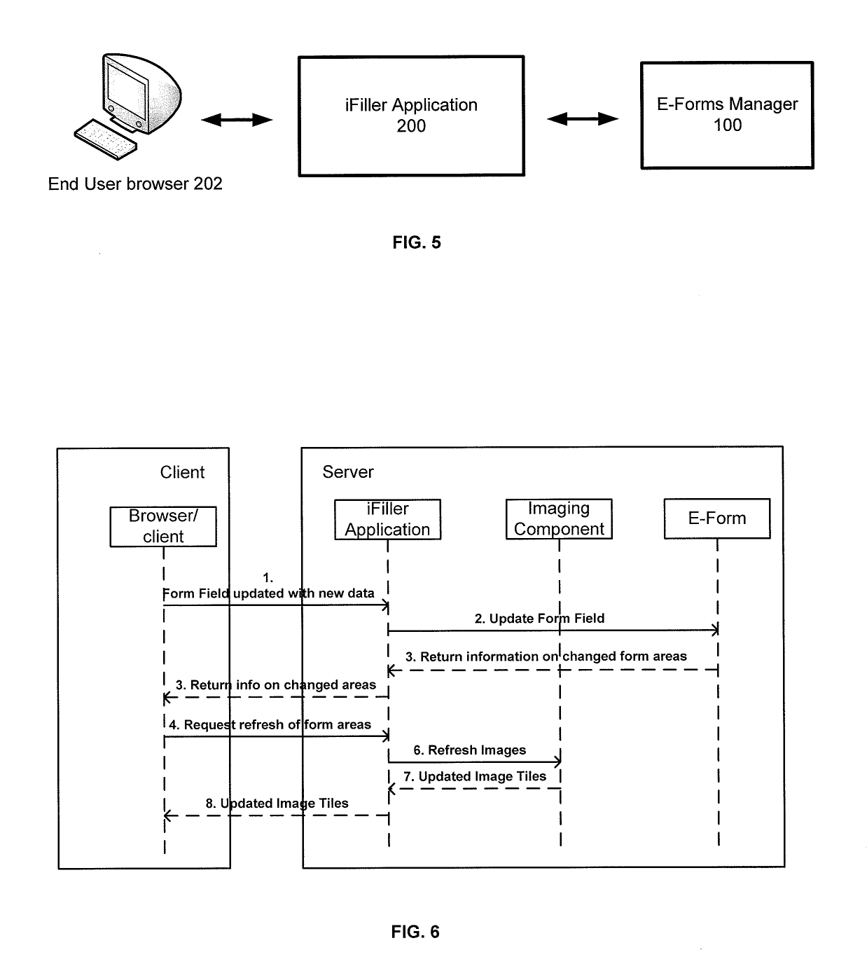

FIG. 5 shows an exemplary embodiment wherein End User 7 may access e-form 20 through End User browser 202, using iFiller Application 200. End User browser 202 may be included in End User computer 7. iFiller Application 200 is a server-based application that interacts with EFM 100 to provide a purely browser-based delivery and presentation of e-forms from the repository of published e-forms in EFM 100. In this embodiment, access to e-form 20 does not require the installation of any additional software or browser plug-ins.

iFiller Application 200 is a software program that is designed as an add-on to EFM 100, such that all the e-forms and associated authentication settings may be accessed by the iFiller Application 200, without requiring any modifications. Form Administrator 102 may configure authentication settings for e-form 20, just once, using the process described above for e-form download using Filler software, and the same settings will apply for iFiller Application 200. Similarly, all other e-form automation features available on Filler software, such as submission, signing and Auto-fill of e-forms, are also made available through the iFiller Application 200.

FIG. 6 is a schematic which represents the sequence of events that take place when End User 21 updates a form field in e-form 20 using a browser. For purposes of this illustration, it is assumed that End User 21 has cleared any authentication requirements set by Form Administrator 102. A form field in e-form 20 may be updated by typing into a data entry control overlaying the form, or by clicking on a control such as a checkbox, radio button or dropdown menu. The End User browser 202 sends a request to iFiller Application 200 with information corresponding to the updated form field, along with associated data values, if any.

Next, the iFiller Application 200 updates the representation of e-form 20 in the memory location within EFM 100 where the original e-form 20 is stored, such that the modified values of the field and any associated data values are resident in e-form 20. Information about visual changes due to the updates in the representation of e-form 20 are conveyed back to the browser 202, along with associated data and state changes if any.

End User browser 202 sends a request to iFiller Application 200 for updated form page areas, or “Tiles”, along with coordinates of the tiles and a “zoom level” value corresponding to the magnification and resolution of the tile image on the browser 202. The iFiller Application 200, in turn, requests the tiles from the application's imaging component. In response, the tiles are rendered to the iFiller Application 200 in a format such as a PNG image, in byte streams. These images are sent back to End User browser 202 and displayed with the changes corresponding to the form field update reflected on the current image of e-form 20.

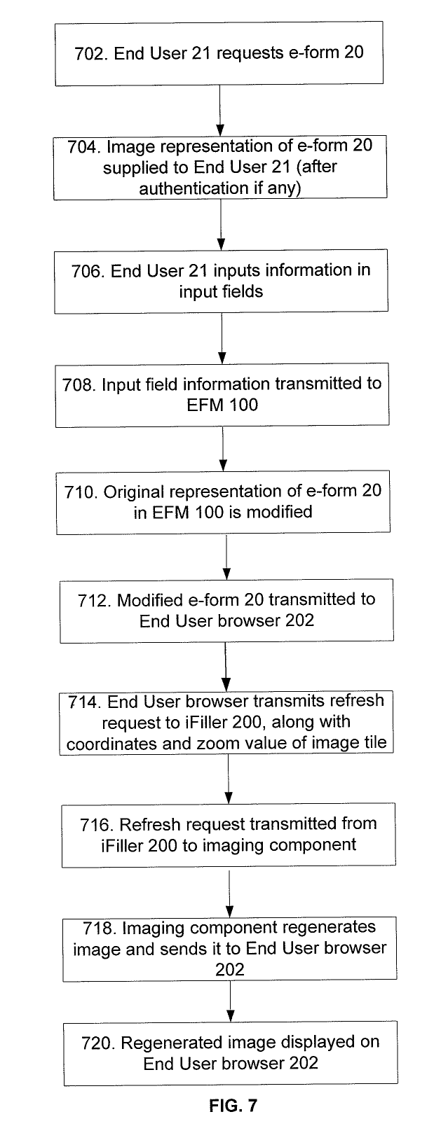

The process steps described above is depicted in the flow chart of FIG. 7. The process begins with identifying an e-form 20 which includes predetermined fields, for download into an End User browser 202 from an electronic form repository in a server location, such as EFM 100, wherein the predetermined fields are modifiable by a user and the browser is an application residing on the End User computer 7 (Step 702). The next step is providing an image representation of the electronic form to the End User browser 202 (Step 704). The End User 21 then inputs information into the predetermined fields, through the medium of the browser and the predetermined fields are modified in accordance with the information entered by the End User 21 (Step 706). Information corresponding to the modified fields is transmitted from the End User computer 7 to the iFiller application 200 residing in EFM 100 at a server location (Step 708). The original representation of e-form 20 in the repository is modified in accordance with the modified fields to create a modified e-form 20, by iFiller application 200. (Step 710). Information corresponding to the modified e-form 20 is then transmitted from the server location to End User browser 202 (Step 712). The End User browser then transmits a refresh request for one or more updated image tiles iFiller application 200, wherein the image tiles correspond to areas of modified fields in the modified electronic form, and wherein the request includes information corresponding to a coordinate representation of the image tiles and a zoom level value corresponding to a magnification and resolution of the image tiles (Step 714). The refresh request is in turn transmitted from the Filler application to an application's imaging component (Step 716). The application's imaging component responds by generating updated image tiles and transmits the updated image tiles to iFiller Application 200. (Step 718). iFiller Application 200 transmits an updated image of e-form 20 to End User browser 202, which displays the updated image of e-form 20 (Step 720).

In contrast to conventional browser-based data collection applications, an e-form accessed through iFiller Application 200 is not just an HTML interface that collects data to store in a data base. The e-form 20 represents a document that is opened by End User 21 on a server, which is being rendered in real time back to the browser as End User 21 makes changes to the document. Thus, all the advantages associated with downloadable Filler software, are made available through a browser. The benefits of iFiller Application 200 are easily seen with reference to enforceability of electronic signatures and legal agreements to which they are applied, because, not only can the data entered into e-forms be collected and processed from the browser, but the document itself may be digitally signed, downloaded and saved by End Users, routed for approval, and stored in a variety of ways by the organization to which it was submitted.

In further contrast to conventional browser based data collection applications, End Users may optionally download e-forms that they are currently working on in a browser (through a setting in EFM 100), and save this “work in progress” locally. This allows End Users to continue working on an e-form “offline” when they are not connected to the internet, to circulate a draft version of an e-form offline within the End User's organization, or return to the “online” browser interface to iFiller Application 200 at any point in time, upload the e-form, and resume working on it.

Compared to conventional HTML or other web based applications, iFiller Application 200 enables organizations to quickly and easily create rich data capture solutions that include features such as signing attachments, routing, database and enterprise integration. Instead of generating simple HTML-based alternatives of the forms, iFiller Application 200 gets the actual e-form 20 from the repository in EFM 100, renders it graphically for End User 21 and allows End User 21 to interact with e-form 20 in the same way as facilitated by the Filler software. This provides a true server-side document which is identical in presentation to its Filler counterpart. Submission of the e-form 20 results in a document artifact being sent into EFM 100 that can contain digital signatures, attachments and other important items in addition to field data, and which can be stored on the back-end file system or in a content repository.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method of modifying an electronic form, the method comprising:
identifying an electronic form, which includes predetermined input fields, for download into a browser from an electronic form repository in a server location, the input fields being modifiable by a user and the browser being an application residing on a user computer;
providing an image representation of the electronic form to the browser;
inputting information by the user into at least one input field through the medium of the browser;
transmitting information corresponding to the modified input field from the user computer to a Filler application;
modifying an original representation of the electronic form in accordance with the modified input field to create a modified electronic form, such that an image tile of the original representation of the electronic form is replaced with an updated image tile, the updated image tile incorporating the modified input field;
transmitting an updated image of the electronic form from the Filler application to the browser, the updated electronic form image including the updated image tile; and
displaying the updated electronic form image in the browser.

2. The method of claim 1, wherein the predetermined fields include a text box configured to accept text information from the user computer, a check box, and/or a dropdown menu.

3. The method of claim 1, wherein the Filler application resides in the server location.

4. The method of claim 1, wherein the step of modifying an original representation of the electronic form in accordance with the modified input field to create a modified electronic form, further comprises transmitting a refresh request for an updated image tile from the browser to the Filler application, and wherein the refresh request includes information corresponding to a coordinate location of the input field and a zoom level value corresponding to a magnification and resolution of the image representation of the input field.

5. The method of claim 4, wherein the refresh request is transmitted from the Filler application to an imaging component and the updated image tile is generated by the imaging component.

6. The method of claim 1, wherein the user computer is connectable to the server via a Wide Area Network (WAN).

7. The method of claim 1, wherein the user computer is connectable to the server via a Local Area Network.

8. The method of claim 1, further comprising:
identifying a form administrator for the electronic form;
associating an authentication mechanism to the electronic form, wherein the form administrator may create an authentication requirement for the user, prior to download of the electronic form.

9. The method of claim 8, wherein an authentication scheme is selectable by the form administrator, from a plurality of authentication schemes associated with the authentication mechanism

10. The method of claim 8, wherein a user name field and a password field is optionally associated with the authentication mechanism for identifying a particular user.

11. A server configured to modify electronic forms comprising:
an electronic form with modifiable predetermined input fields; and
a Filler application for selectively providing an image representation of the electronic form to a user,
wherein a modified image representation is generated,
wherein the image representation of the electronic form is modified in accordance with a modified input field supplied by the user, and
wherein the modified image representation is transmitted to the user.

12. A user system configured to modify electronic forms comprising:
a browser configured to download an image representation of an electronic form with at least one predetermined input field from a server;
a Filler application which facilitates inputting information from a user in the input field, such that the image representation of the input field is modified, and information corresponding to the modified image representation of the input field is transmitted to the server;
a display mechanism configured to display an updated image representation of the electronic form received from the server, wherein the updated image representation of the electronic form incorporates the information supplied by the user.

13. A method for entering data into a form, the method comprising:
providing an image representation of an electronic form to a user, the electronic form being selectable from a plurality of electronic forms;
facilitating input of user data into a predetermined field of the image representation of the electronic form;
regenerating the image representation of the electronic form to include the inputted user data; and
replacing the image representation of the electronic form originally provided to the user with the regenerated image representation of the electronic form.

14. The method according to claim 13, wherein the image representation of the electronic form is provided to the user via a browser residing on a user computer.

15. The method according to claim 13, wherein only a browser, which resides on a user computer, facilitates the input of user data.

16. The method according to claim 13, wherein the image representation of the electronic form is regenerated to include the inputted user data by an application residing on a server computer that is remote to a user computer.

17. The method according to claim 16, wherein the server computer is connectable to the user computer via a wide area network or a local area network.

18. The method according to claim 13, wherein a pixel field, which corresponds to an area location of the predetermined field within the image representation of the electronic form, is replaced such that the regenerated image representation of the electronic form is displayed to the user with the inputted user data.
